(19) United States
(12) Patent Application Publication
(10) Pub. No.: US 2026/0228245 A1
(43) Pub. Date: Aug. 6, 2026

(54) REAL-TIME GEOSPATIAL QUERYING AND ANALYSIS USING HIERARCHICAL INDEXING AND NATURAL LANGUAGE PROCESSING

(71) Applicant: xMap, Inc., Wilmington, DE (US)

(72) Inventors: Mohamed Reda Elsayed Mohamed, Tokyo (JP); Yassin Ennajih, Tokyo (JP); Mohamed Farid Attaallah, Toronto (CA); Ayman Imam Ahmad Ibrahim, Tokyo (JP)

(73) Assignee: xMap, Inc., Wilmington, DE (US)

(21) Appl. No.: 19/434,026

(22) Filed: Dec. 29, 2025

Related U.S. Application Data
(60) Provisional application No. 63/752,629, filed on Jan. 31, 2025.

(51) Int. Cl. G06F 16/29; G06F 16/22; G06F 16/242; G06F 16/248

(52) U.S. Cl. CPC G06F 16/29; G06F 16/2246; G06F 16/243; G06F 16/248

(57) ABSTRACT

Techniques for real-time query processing and geospatial analysis are disclosed. In one example, the techniques include responsive to receiving, from a computing device via a network, a natural language query corresponding to a geographic region, determining a natural language response based on geospatial data retrieved from a database system, wherein the geospatial data is indexed by the database system to maintain geospatial relationships between entities associated with the geographic region and entities identified in the natural language query, and generating, for output to an electronic display, content configured to present the natural language response

### BENEFIT CLAIMS; RELATED APPLICATIONS; INCORPORATION BY REFERENCE

This application claims the benefit of U.S. Provisional Patent Application 63/752,629, filed Jan. 31, 2025, which is hereby incorporated by reference.

### TECHNICAL FIELD

The present disclosure relates to geospatial information systems. In particular, the present disclosure relates to systems and methods for real-time geospatial querying and analysis utilizing hierarchical geospatial indexing structures and natural language processing techniques.

### BACKGROUND

Geospatial Information Systems (GIS) are widely-used tools for managing, analyzing, and visualizing spatial data across various industries, including urban planning, real estate, environmental monitoring, and retail site selection. While there is considerable growth in geospatial analysis space in terms of application complexity and dataset capacity, traditional GIS platforms are likely to find it difficult to accommodate future usage. For instance, current data retrieval methods have proven inefficient at handling the geospatial datasets used by such traditional GIS platforms, resulting in increased latency and decreased system performance.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

In general, the disclosure describes techniques that enable efficient, cost-effective, and overall improved operation. The described techniques provide solutions and/or mitigations for overcoming several limitations in traditional GIS systems. One example limitation is the complexity of GIS user interfaces which have increased to the point of becoming burdensome, rendering them less accessible to non-expert users. This is due to conventional GIS systems typically requiring specialized technical expertise to perform detailed spatial analyses. As another limitation, traditional GIS platforms also utilize fragmented data sources even though integrating diverse datasets from multiple sources presents challenges such as data incompatibility, lack of standardization, and difficulties in maintaining data synchronization. As yet another limitation, existing systems lack the capability to process and analyze data in real-time, hindering timely decision-making and responsiveness to dynamic conditions. Other limitations addressed by the present disclosure include insufficient customization options, inefficient data retrieval such as for large-scale geospatial datasets, and inadequate real-time processing. To illustrate, by way of example, the restrictions placed on current customization options, consider that existing systems rely on predefined geographic regions for targeted analyses instead of user-defined or customized regions of interest.

The details of one or more examples are set forth in the accompanying drawings and the description below. Other features, objects, and advantages will be apparent from the description and drawings, and from the claims.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example system architecture in accordance with one or more embodiments;

FIG. 2 illustrates an example schematic representation of a hierarchical geospatial indexing structure in accordance with one or more embodiments;

FIG. 3 illustrates an example set of operations for geospatial analysis in accordance with one or more embodiments;

FIG. 4 illustrates an example embodiment of the system architecture of FIG. 1;

FIG. 5 illustrates an example set of operations for an error handling mechanism in accordance with one or more embodiments;

FIG. 6 illustrates an example schematic representation of a dynamic function response mechanism in accordance with one or more embodiments;

FIG. 7 illustrates an example index for geospatial analysis in accordance with one or more embodiments; and

FIG. 8 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. GEOSPATIAL INFORMATION SYSTEM ARCHITECTURE
3. EXAMPLE HIERARCHICAL STRUCTURE
4. EXECUTING A GEOSPATIAL ANALYSIS TASK
5. EXAMPLE EMBODIMENT
6. AUTOMATICALLY CORRECTING AN ERROR IN A QUERY
7. EXAMPLE INDEX
8. EXAMPLE FUNCTION ORCHESTRATION
9. MICROSERVICE APPLICATIONS
10. HARDWARE OVERVIEW
11. MISCELLANEOUS; EXTENSIONS

### 1. General Overview

The present disclosure describes a number of improvements for traditional GIS systems. For one, the present disclosure describes technology that addresses the various needs indicated above. This includes an improved geospatial intelligence system that is enhancement over traditional GIS systems by enabling intuitive definition of custom geographic areas, supporting natural language querying to make complex analyses accessible to non-technical users, seamlessly integrating data from multiple, diverse sources, providing efficient, real-time data retrieval and processing, employing advanced error-handling mechanisms to ensure accuracy and reliability, among others.

A number of technologies combine to build various embodiments of the improved geospatial intelligence system described herein. To illustrate by way of example, an interactive map interface enables customizable geofencing where a user can specify the geographic boundaries of geospatial analysis tasks by drawing a polygon. Another example component enables natural language query processing in real-time (e.g., a chatbot mechanism) with the polygon. Yet another component implements a hierarchical geospatial indexing structure for running querying against a database system that is in control over a number of data stores. By integrating at least these components, the various embodiments described herein provide an intuitive platform with a chatbot mechanism for geospatial analysis.

One or more embodiments include systems, methods, and computer-readable storage medium configured to perform operations including responsive to receiving, from a computing device via a network, a natural language query corresponding to a region within a geographic area, determining a natural language response based on geospatial data retrieved from a database system, wherein the geospatial data is indexed by the database system to maintain geospatial relationships between entities associated with the region and entities identified in the natural language query and generating, for output to an electronic display, content configured to present the natural language response.

The present disclosure provides systems and methods for real-time geospatial querying and analysis by integrating hierarchical geospatial indexing structures with natural language processing (NLP) techniques. There are a number of advantages in employing the hierarchical geospatial indexing structure described herein for most (if not all) geospatial analysis tasks, let alone for resolving geospatial queries, specifically. For one, hierarchical indexing reduces the computational complexity of spatial queries. It also enables efficient aggregation and drill-down analyses across different geographic scales. The hierarchical geospatial indexing structure also is better suited for geographic data search/retrieval and therefore, more effective at generating responses to a user's geospatial queries.

One or more embodiments include an interactive map interface capable of customizable geofencing. In one embodiment, a user can use the interactive map interface to define boundaries for a specific map region within a larger geographic area and then, use a query interface to submit queries requesting localized information for that specific map region. Customizable geofencing makes such information accessible to users without specialized technical knowledge in GIS technology. One or more embodiments further leverage an index having a hierarchical geospatial indexing structure to address the limitations of existing GIS systems by enhancing data integration, optimizing scalability and performance, providing advanced error-handling, enabling dynamic backend function orchestration, improving user interaction, and delivering precise geospatial data insights in real-time.

One or more embodiments described in this Specification and/or recited in the claims may not be included in this General Overview section.

### 2. Geospatial Information System Architecture

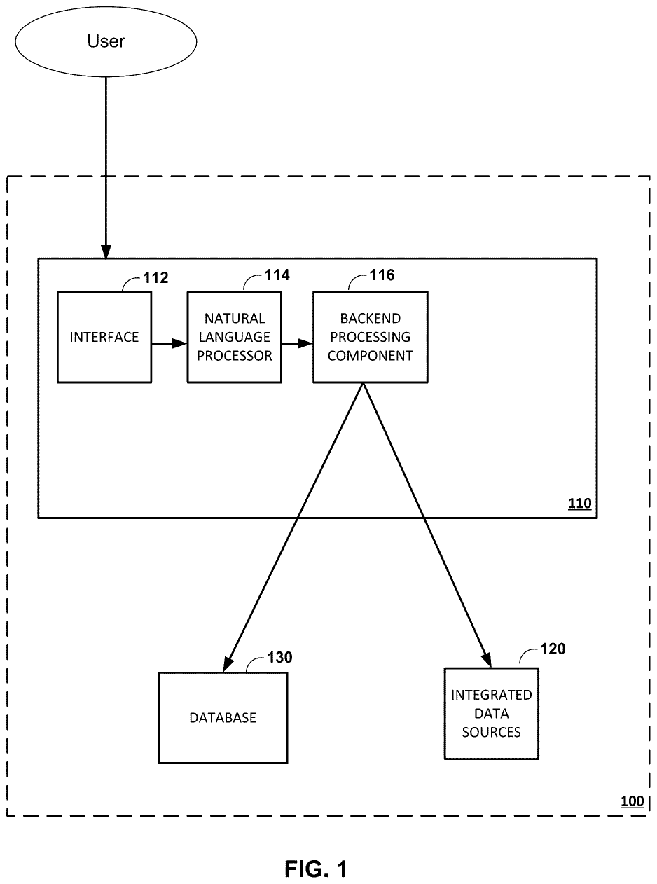

FIG. 1 illustrates a system 100 in accordance with one or more embodiments. As illustrated in FIG. 1, system 100 includes a number of components including a physical or virtual computing device (i.e., a server) for running software applications and providing computing services. FIG. 1 also features an application service 110 that provides an interface 112, a natural language processor (NLP) 114, a backend processing component 116, among other functionality.

In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to applications built on a microservice architecture are described below in Section 9, titled “MICROSERVICE APPLICATIONS.”

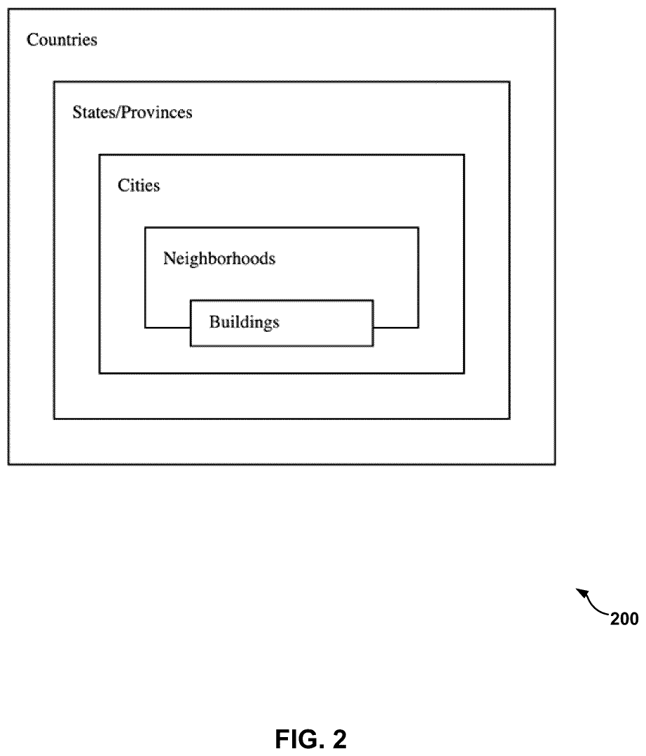

In one or more embodiments, the system 100 refers to hardware and/or software configured to perform operations described herein for geospatial analysis. Examples of operations for geospatial analysis are described below with reference to FIG. 2.

In an embodiment, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

Each of the integrated data sources 120 refers to a data repository. In one or more embodiments, a data repository is any type of storage unit and/or device (e.g., a file system, database, collection of tables, or any other storage mechanism) for storing data. Further, a data repository may include multiple different storage units and/or devices. The multiple different storage units and/or devices may or may not be of the same type or located at the same physical site. Further, a data repository may be implemented or executed on the same computing system as the server 110. Additionally, or alternatively, a data repository 104 may be implemented or executed on a computing system separate from the server 110. The data repository may be communicatively coupled to the server 110 via a direct connection or via a network.

Examples of the integrated data sources 120 include, but not limited to: public datasets comprising census data, environmental reports, and transportation networks; proprietary databases containing real estate listings, economic indicators, and business directories; web-crawled information from online platforms and social media. The system 100 may further enhance the integrated data sources 120 by way of harmonization through format standardization and attribute mapping.

Similar to the integrated data sources 120, a data repository may be configured into a database 130. Alternatively, a physical server operative to run the application 110 may also include the database 130. Information describing the database 130 may be implemented across any of components within the system 100. However, this information is illustrated outside of the server 110 for purposes of clarity and explanation.

In at least one embodiment, the database 130 operates as a database system that employs spatial indexing methods, such as binary search trees, to build an index suitable for efficient geospatial querying and analysis. In one embodiment, the database 130 builds a hierarchical geospatial index as a tree-based index in which a lower-lever (child) entity node references its next higher-level (parent) entity node, forming a tree or tree-like structure, and each specific entity is associated with a node that comprises entity-related data, metadata, and other information. Such a hierarchical geospatial index can be configured for searching datasets that are stored across multiple remote data stores. Examples of tree-based indexes that can be built from at least two nodes include R-trees, quad-trees, k-d trees, and other spatial indexing methods.

It should be noted that the above-described tree-based indexes are example embodiments of a hierarchical geospatial indexing structure. In another embodiment, a tree-based index is partitioned according to a multi-level hierarchy. In one embodiment, the database 130 builds a multi-level hierarchical geospatial index and thereby, can be referred to as a multi-level hierarchically indexed geospatial database. Regardless of the specific structure being implemented, the database 130 is configured to organize datasets into nested entity nodes (e.g., for buildings, neighborhoods, cities, states or provinces, and countries) and provide a suitable index for accessing such datasets. By doing so, retrieving geospatial data from the database 130 includes traversing only nodes whose geometries intersect a certain geographic region within a larger geographic area. The geographic region can be identified in a number of ways, such as by requesting that the user select a pre-defined region or provide input data indicative of a user-defined polygon.

The system 100 includes various hardware/software components (e.g., the application 110 or another software application) that are configured to access the database 130 and retrieve datasets having geospatial data. The system 100 may further enhance query processing and data retrieval via the database 130 through scalability and performance optimization techniques (e.g., caching mechanisms, such as Least Recently Used (LRU) caching), which are employed to reduce latency. The system 100 also supports dynamic resource allocation to handle high query volumes efficiently.

The application service 110 (or simply “application 110”) generally refers to software code that, when executed, operates a software application on a user's computing device. Specifically, the application service 110 operates as a software application in connection with a cloud service subscription (e.g., a software-as-a-service (SaaS) model subscription). The system 100 provisions the application service 110 for real-time geospatial querying and analysis by integrating hierarchical geospatial indexing structures with natural language processing (NLP) techniques among other improvements.

In one or more embodiments, interface 112 refers to hardware and/or software configured to facilitate communications between a user and the application 110. Interface 112 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 112 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 112 is specified in one or more other languages, such as Java, C, or C++.

As an output module, the interface 112 enables various forms of user interaction with presented content, thereby enabling actions including: adjusting visualization parameters such as color schemes, data ranges, and layer opacity; accessing detailed information about specific data points through interactive elements like tooltips or pop-up windows; and/or refining queries based on initial results by modifying parameters directly within the interface. The interface 112 can be configured to further enhance the content presented on the GUI through visualizations such as heat maps, markers, and statistical charts.

The NLP 114 refers to a software module that implements an LLM and operates as a generative AI component for the application 110. One example NLP 114 may implement an LLM that is configured for natural language query interpretation. A suitable embodiment for the LLM can be a transformer-based model such as one based on BERT or GPT. The above-mentioned application 110 can instrument the above LLM and generate a chatbot mechanism as (at least part of) the interface 112.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

The backend processing component 116 of the application service 110 generally refers to software code for geospatial querying and analysis. As described herein, the backend processing component 116 interacts with the database 130, for example, by issuing requests for and then extracting geospatial datasets via an API exposed by that database system.

In one embodiment, the system 100 of FIG. 1 employs a hierarchical geospatial indexing structure to build an index dedicated towards organizing geographic information. The system 100 can configure the index into a database system that is operative to search and retrieve specific entity data. As described herein, such a database system can be used to support an application service 110 that provides geospatial querying and analysis in a chatbot mechanism.

Users can leverage the application service 110 for geospatial analysis by way of user-submitted geospatial queries. A user-submitted query can prompt the application service 110 to perform certain operations, such as to invoke various functionality of the above-mentioned database system. To generate query results for an appropriate response to the user-submitted query, the backend processing component 116 invokes a sequence of API functions for extracting various datasets, and in turn, the database 130 returns the query results for presentation via the interface 112.

In one embodiment, a chatbot mechanism operates on the interface 112 through which users can engage the application service 110 in a conversation, for example, by submitting natural language queries and viewing corresponding natural language query responses. For each query submission, the NLP 114 determines a query intent that the backend processing component 116 uses in selecting one or more database 130 API functions to call. To determine the query intent, the NLP 114 can leverage a number of datasets including previous submitted query and query responses in the same conversation and/or previous conversations.

In one embodiment, the application service 110 avails an improved index to enhance geospatial analysis task execution with respect to the database 130. The unique hierarchical geospatial structure of that improved index can be leveraged for enhancing the various geospatial analysis tasks that are performed in connection with a cloud service subscription. For instance (and further explained in detail below), the unique hierarchical geospatial structure of the improved index enables a more immersive user experience with respect to serving their geospatial information needs. The application service 110 can operate a real-time chatbot mechanism that engages in human-like conversations to serve user data requests (e.g., map data requests). As another improvement, the application 110 can use the real-time chatbot mechanism to provide immediate responses to user queries.

To build an index for the database 130, entity types are first organized hierarchically and then, those entity types are used for labelling geospatial datasets. By doing so, the geospatial datasets stored in the database 130 can be organized into the same multi-level hierarchy (i.e., the unique hierarchical geospatial structure described herein). An entity that maps to a lower hierarchical layer can be considered a nested entity for an entity that maps to a higher layer. For instance, entities can be categorized into layers based on a geospatial relationship and other factors such as size such that entities of a certain size become nested entities for an entity of a larger size. An architecture built on nesting entities involves creating associations between different entities based on their geospatial relationship(s). To illustrate by way of example, an entity may be a political subdivision of a larger (sovereign) territory. corresponding to separate entity categories that have a geospatial relationship with each other in some form.

The system 100 of FIG. 1 can organize available geospatial datasets from the integrated data sources 120 into a multi-layered hierarchical structure where each layer represents both a geographic area and its associated data attributes.

The present disclosure further describes additional enhancements to traditional GIS systems that the improved system 100 described herein can incorporate. For one, by implementing an interactive map interface, the application 110 allows precise delineation of geographic boundaries without relying on predefined zones (i.e., customizable geofencing). The application 110 may generate the interactive map interface for presentation to the user via an electronic display, and in turn, the user can define specific areas of interest, such as by drawing custom polygons on the interactive map interface. The application 110 may run an application client graphical user interface (GUI) on the user's device and the interactive map interface may be a feature of that client GUI.

As another improvement, the application 110 can leverage the hierarchical structure to enable dynamic backend function orchestration for natural language query evaluation. In one embodiment, the backend processing component 116 dynamically selects and triggers backend functions based on the interpreted query context, allowing efficient handling of diverse query types and data retrieval requirements.

Optionally, the system 100 further includes an error-handling module that, when executed for the application 110, is configured to detect user input errors in the natural language queries, suggest corrections by comparing the input against a database of known terms using string similarity algorithms such as Levenshtein distance, and automatically retry the query with corrected inputs to ensure accurate data retrieval.

### 3. Hierarchical Geospatial Structure

FIG. 2 illustrates an example hierarchical geospatial indexing structure 200 for executing geospatial analysis tasks in accordance with one or more embodiments. As illustrated, the hierarchical geospatial indexing structure 200 (hereinafter simply “structure 200”) includes a nested arrangement of entities with the following labels: “Countries,” “states/provinces,” “cities,” “neighborhoods,” and then, “buildings” as the innermost entity. As illustrated, the structure 200 arranges entities based on geospatial (or “containment”) relationships where each geographic entity level/layer represents entities that are contained within a higher layer entity. By arranging entities to maintain their geospatial relationships, the structure 200 enables a number of improvements to computing systems engaged in geospatial analysis.

Given a contiguous geographic region, the structure 200 identifies specific sub-regions therein as entities that are in the nested arrangement reflecting their real-world geospatial relationships. Each sub-region may include smaller sub-regions that are entities themselves. It should be noted that the present disclosure does not restrict the hierarchical geospatial indexing structure 200 with respect to political nomenclature; for instance, the entity types “Countries” and “states/provinces” may refer to any territorial polity and subdivision therein including but not limited to federated states.

A computerized system (e.g., the system 100 of FIG. 1) can employ the above-mentioned structure 200 to improve execution of any application services with geospatial data and geospatial analysis tasks. As described herein, the structure 200 indexes datasets having various information including geospatial information. By doing so, the computerized system 100 identifies specific datasets for retrieval quickly and without substantial delay. The computerized system 100 can also support multi-scale analysis data retrieval when communicating with a large number of geospatial data sources. Often operating with substantial quantities of geospatial data, the system 100 can direct queries to specific layers of the structure 200. Any layer(s) of the structure 200 can be queried independently or in combination, thereby enabling complex geospatial analysis across multiple dimensions. The structure 200 also supports both vertical (cross-layer) and horizontal (within-layer) relationships.

### 4. Executing a Geospatial Analysis Task

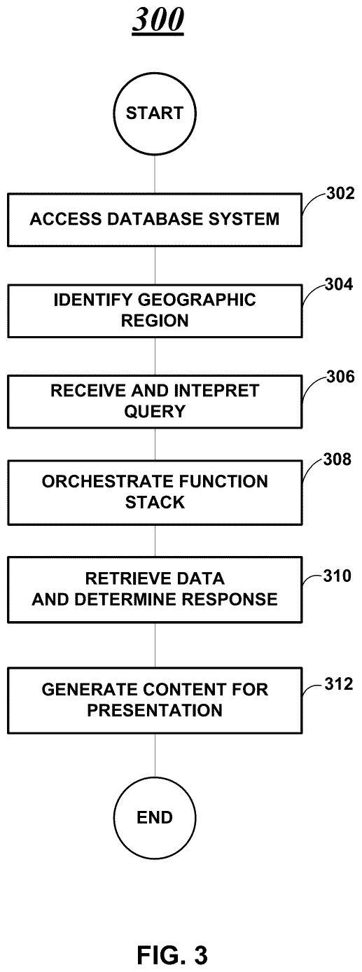

FIG. 3 illustrates an example set of operations 300 for executing a geospatial analysis task in accordance with one or more embodiments. One or more operations illustrated in FIG. 3 may be modified, rearranged, or omitted all together. Accordingly, the particular sequence of operations illustrated in FIG. 3 should not be construed as limiting the scope of one or more embodiments.

FIG. 3, more particularly, is a flow diagram depicting the example set of operations 300 as a process flow of the system 100 of FIG. 1. In an embodiment, the system 100 accesses a database system such as the database 130 of FIG. 1 (Operation 302). As described herein, the database 130 is a hierarchical geospatial indexing database system in which an index is built using a hierarchical geospatial indexing structure such as the structure 200 of FIG. 2. The indexing structure itself involves setting levels (e.g., geospatial layers) corresponding to separate categories, each having a geospatial relationship with each other in some form. A first geospatial layer can be configured with at least one entity type. As an example, the first geospatial layer can include the entity or entities encompassing the most area, which are the country or countries included within a geographic area. Then, within each country, a number of different entity types can be configured to each encompass at least some area or position. A second geospatial layer can be configured with smaller entity types such as individual states or provinces. A third geospatial layer may identify buildings of a certain size, and so forth. Datasets for each entity type and for each geospatial layer can be queried independently or in combination, allowing for complex spatial analysis across multiple dimensions. Entities (e.g., buildings, neighborhoods, cities, states or provinces, and countries) are organized hierarchically according to the above structure or, alternatively, based on any schema (e.g., based on size).

To build the index for the database system, various datasets associated with the entities can be labelled with a corresponding entity type and then, organized into the above multi-level hierarchy. Having such an index allows a software application, such as the application 110 of FIG. 1, to retrieve specific datasets almost instantaneously and with a negligible retrieval time. Because the index can be used for multiple, disconnected data stores, the application can perform multi-scale analyses for generating a query response.

In an embodiment, the system 100 identifies a geographic region (Operation 304). In one embodiment, the geographic region is a specific map region and a portion of a map representation of a larger geographic area. A user can use an interactive map interface to define boundaries for the specific map region. When the user submits queries requesting geospatial data for that specific map region, retrieving the geospatial data from the database system includes traversing nodes in the above-described index whose geometric data intersects the specific map region within the larger geographic area. Nodes have geometric data outside of the specific map region can be skipped. In one embodiment, the user can select a pre-defined region or provide input data indicative of a user-defined polygon.

In an embodiment, the system 100 receives and interprets a query (Operation 306). The query described herein refers to a natural language query that includes or entails geospatial analysis. A user requesting accurate geospatial analytics information submits the natural language query to the system 100. In one embodiment, the server 110 of FIG. 1 receives, via the interface 112 depicted in FIG. 1, the query from a user who is requesting accurate geospatial analytics. As described herein, the server 110 can run a software application (e.g., the application 130 of FIG. 1) that operates, in part, on the user's computing device. Via the interface 112, the software application can present content on the user's electronic display and receive the user's natural language queries.

In an embodiment, the system 100 can provide, as a cloud service, operational use of the above-mentioned software application. The software application is configured to instrument an LLM for query interpretation that, when applied to the query, can determine query intent. Upon having the query intent, the software application can use the LLM (or another LLM) to generate an appropriate response. In an embodiment, the system 100 configures the software application to interpret a natural language query associated with the user-defined polygon. The system 100 can define query interpretation for the software application in a number of ways such as by evaluating query intent, analyzing context data (e.g., conversational context), identifying entities, and/or determining parameters;

In an embodiment, the system 100 orchestrates a function stack for retrieving related data from a database system (Operation 308). The function stack can be orchestrated (e.g., dynamically) to optimize geospatial analytics tasks and data retrieval for datasets from a database system. As described herein, the datasets store information that the user requires for the geospatial analytics tasks, thereby requiring backend functions capable of accessing the database system having the above-mentioned index to retrieve relevant data efficiently. The system 100 can leverage, for building the index, spatial indexing methods to minimize search time and resource consumption when orchestrating the function stack and generating the query response. The system 100 can leverage the function stack to dynamically select and trigger one or more backend functions based on the interpreted query context.

In an embodiment, the system retrieves data from executing the function stack (Operation 310). The system 100 can execute the function stack over a network connection with a database system and in response, receive messages having the requested information as message payloads. The system 100 may process the retrieved data according to the requirements of the query and may include a statistical analysis (e.g., calculating averages, medians, trends, and/or the like), spatial analysis (e.g., buffering, overlay analysis, proximity calculations and/or the like), and temporal analysis (e.g., time-series analysis, trend detection, and/or the like). In one embodiment, the system enables the comparative analysis of the retrieved geospatial data across different geographic scales by aggregating and summarizing data at each proximity level of a geographic map region (e.g., of the user-defined polygon).

In an embodiment, the system determines a response to the natural language query (Operation 310). The system 100 can use the requested information for the geospatial analytics tasks and then, generate accurate geospatial information for inclusion in the response. The system 100 can apply the above-mentioned LLM to generate a natural language response to the query.

In an embodiment, the system generates content for presentation of the response (Operation 312). The system 100 can generate textual content for presenting the query response to the user. The system 100 can access user preferences to determine additional content to present. For instance, the system 100 can present at least a portion of the response on the map interface.

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

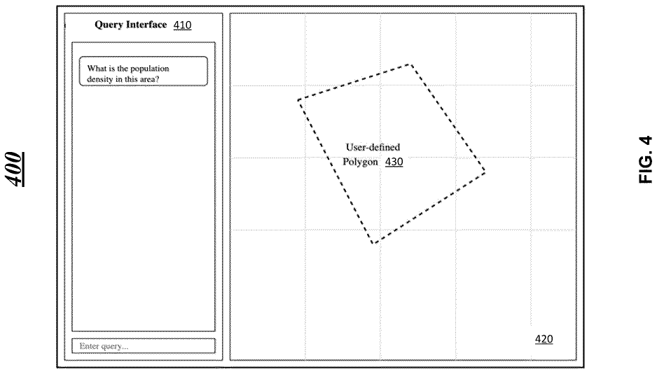

FIG. 4 illustrates an example embodiment of the system architecture of FIG. 1 in the form of an interactive user interface (UI) 400 for geospatial analysis as described herein. In particular, FIG. 4 illustrates the interactive UI 400 as a combination of graphical user interface (GUI) components through which the system 100 (e.g., a computing device) may receive various input including user provided input and present, via an element display, various output.

One example component, which may be known as a chat component, of the interactive UI 400 is chat-based natural language query interface 410 (referenced herein as the query interface 410). The query interface 410 may be any UI element configured to receive, as input, natural language queries and (if appropriate) return, as output, natural language responses. For a second component, the interactive UI 400 further provides a map component in the form of map interface 420 through which the system can receive various geographic information.

As depicted in FIG. 4, a user-defined polygon 430 illustrates an example of the geographic information that can be entered into the map interface 420. There are a number of instances where the user-defined polygon 430 geofences a specific region in the geographic area being depicted on the map interface 420. The geographic area being covered by the user-defined polygon 430 may be of any geometric shape and include contiguous map sub-regions as well as non-contiguous map regions. In one embodiment, the map interface 420 receives user input and, in response, generates the user-defined polygon 430 over at least a portion of the map region. The user input, for instance, may indicate geolocations (e.g., geographic coordinates) of endpoints of the user-defined polygon 430. A user can also create customized geofences by drawing polygons on an interactive map interface.

As further depicted in FIG. 4, a natural language query interface 440 (simply “query interface”) allows users to input queries in natural language and receive answers in a conversation. The query interface 440 includes GUI components for entering text and presenting various types of content including, but not limited to, text, graphics, audio/video data, and/or the like. FIG. 4 illustrates, as one example query, “What is the population density within this area?” in the query interface 440. This example query is input as text into the query interface 440 and, once submitted, output into a separate UI element along with any query response. Other example natural language queries include: “List all public schools within 2 kilometers of this region.”; and “Show me the average property values in this neighborhood.”.

By entering the example query “What is the population density within this area?”, the user requests specific geospatial information related to the user-defined polygon 430. In response, the system 100 generates a query response having the requested information and then, displays the response in the query interface 440 as part of the conversation.

### 6. Automatically Correcting an Error in a Query

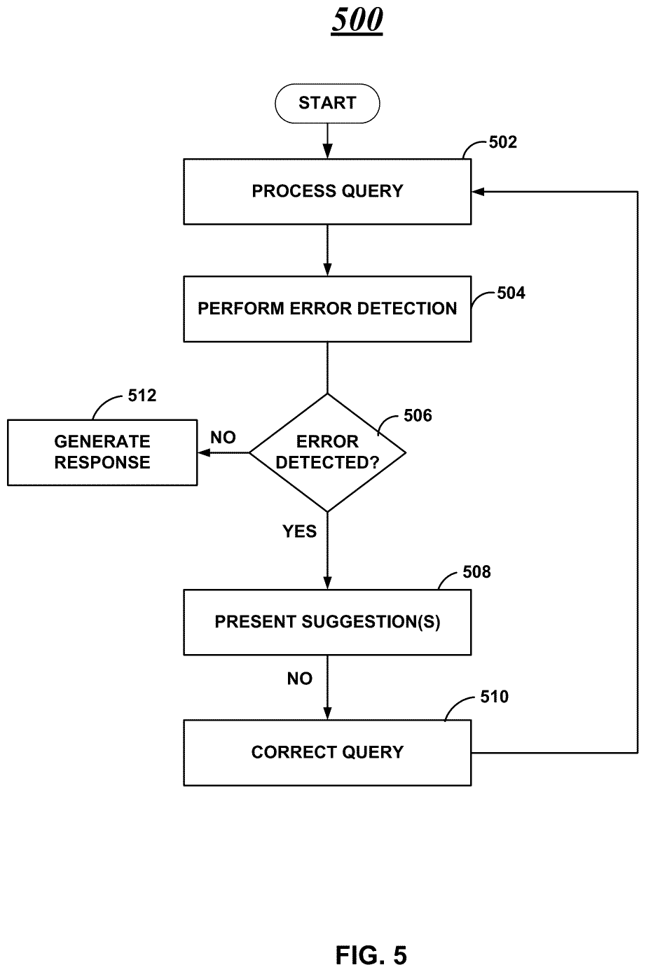

FIG. 5 is a flow diagram illustrating an example set of operations 500 for an error handling mechanism in accordance with one or more embodiments. In general, the error handling mechanism is applied to detect and if needed, correct user input errors such as typographical or incorrect data fieldnames. In one embodiment, the system 100 of FIG. 1 may utilize the error handling mechanism to suggest corrections and automatically retry queries to ensure accuracy.

As described further below, the system 100 can configure the error handling mechanism to run as part of the application 110, for instance, by having the set of operations 500 executed when running a chatbot to interact with a user. In one embodiment, the system 100 of FIG. 1 configures the NLP module 114 to implement the error handling mechanism when responding to queries from the user, the NLP module 114 initiates the example set of operations 500.

In an embodiment, the system 100 processes a query from the user (Operation 502). As described herein, the query refers to a natural language query that is directed to specific geographic region. In one embodiment, the system 100 applies a query interpretation method known as a language model (e.g., LLM), which may be pre-trained for query interpretation or fine-tuned by the system 100, the user, and/or a third-party. The language model may be adapted to recognize a number of errors in natural language queries. In one embodiment, the system 100 can select the language model from a group consisting of transformer-based models, recurrent neural networks, and hybrid models combining rule-based parsing with machine learning.

In an embodiment, the system 100 performs error detection to determine whether there are any potential errors in the user's query (Operation 504). There are a number of applicable error detection techniques including the application of a pre-trained or fine-tuned LLM. In one embodiment, the NLP module 114 executes an LLM that is fine-tuned for query interpretation and identifies typographical mistakes, invalid parameters such as missing or out-of-range attribute values and unsupported units, faulty syntax, incorrect fieldnames, ambiguous references such as unclear entity mentions, among other types of errors. One example error may be a misspelling such as a misspelled device name of a data source.

In an embodiment, the system 100 determines whether an error is detected in the query by any of the error detection techniques (Operation 506). When the system 100 detects an error (“YES” path), the example set of operations 500 proceeds to the following operation(s). In one embodiment, the system 100 presents one or more suggestions to correct the detected error (Operation 508). The system 100 can suggest corrections by way of conventional spell-checking techniques such as using online dictionaries and context-aware spell-check algorithms. The system 100 can suggest corrections by validating parameters, such as by providing acceptable value ranges or units. The system 100 can suggest corrections by way of disambiguation prompts, such as by presenting a question (e.g., in the query interface) requesting the user to clarify any ambiguous terms.

In an embodiment, the system 100 receives an indication to adopt the suggested correction and corrects the query accordingly (Operation 510). In an embodiment, the system 100 receives an indication to adopt the suggested correction and as instructed, modifies the query by adopting the suggested correction (Operation 510). After making the correction, the system 100 automatically retries the query. Feedback can be provided to the user, for instance, feedback indicating the corrections made.

To illustrate by way of example scenario, if the user inputs “Show me the nerest hospitls within 3 miles,” the system 100 can apply the above-mentioned LLM and identify “nerest” and “hospitls” as misspellings. The system 100 can proceed to correcting those misspellings to read “nearest hospitals” instead. One example technique for suggesting corrections involves comparing the user's input query against a database of known terms using string similarity algorithms such as Levenshtein distance.

In another embodiment, the system 100 receives a rejection of the suggested correction accompanied by a user-provided alternative correction, which causes the system 100 to adopt that alternative correction instead of the suggested correction (Operation 510). On the other hand, the system 100 may execute the error detection techniques and find no detectable errors as a result (“NO” path). The various embodiments of the present disclosure have access to a considerable number of resources for suggesting/correcting natural language text; therefore, the system 100 can proceed with query processing with confidence.

In response to failing to detect any errors in the original query or the corrected query (“NO” path), the example set of operations 500 proceeds to the next operation where the system 100 generates a response to the query (Operation 512). The generation of the query response completes the geospatial analysis request and the example set of operations 500 can terminate.

Upon correcting the query (Operation 510), the system 100 continues processing the corrected query, for example, by repeating the example set of operations 500 and retrying the error handing mechanism. In one embodiment, the example set of operations 500 returns to a previous operation to perform query interpretation (Operation 502) and error detection on the corrected query (Operation 504). Alternatively, the system 100 may proceed with generating the natural language query response (Operation 512). In another embodiment, the system 100 receives a rejection of the suggested correction without any alternative correction in which case the system 100 may halt any further query processing.

### 7. Example Index

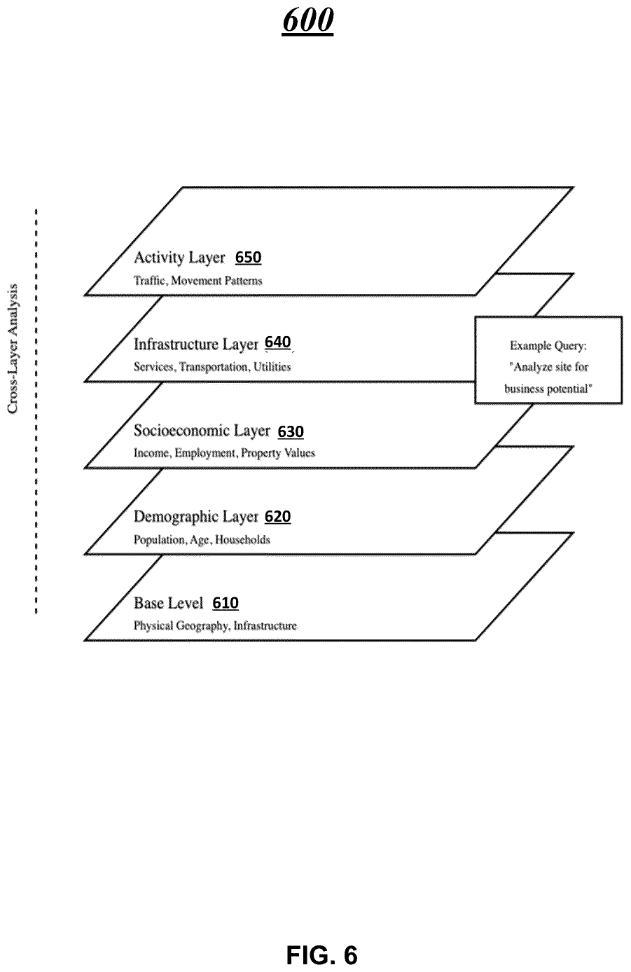

FIG. 6 illustrates an example schematic representation of an index 600 for geospatial analysis in accordance with one or more embodiments of the present disclosure. As explained in detail, the index 600 enables efficient data organization and reflects real-world geospatial relationships, thereby enhancing a cloud system's geospatial analysis capabilities.

The index 600, which is organized according to a hierarchical geospatial indexing structure as described herein, is illustrated as having multiple layers that include a base layer 610, a demographic later 620, a socioeconomic layer 630, an infrastructure layer 640, and an activity layer 650. The geospatial analysis enabled by the index 600 includes a cross-layer analysis in which datasets can be correlated between layers. This includes, for instance, having datasets in each layer that are orthogonal to a lower (or lowest) layer. The organization depicted in FIG. 6 demonstrates interactions between different portions of the same query.

In one or more embodiments, the cross-layer analysis refers to an integration, for instance, by aggregating datasets from multiple hierarchical layers, resolving conflicts between different data resolutions, normalizing metrics across geographic scales, and integrating temporal and spatial dimensions. One example embodiment of the cross-layer analysis includes aggregating datasets at one or more proximities around a user-defined polygon such as the ones described herein (e.g., the user-defined polygon 430 of FIG. 4). Another example embodiment of the cross-layer analysis includes selecting the one or more predefined proximities from a set consisting of radii of 1 km, 5 km, and 10 km. It should be noted that the cross-layer analysis can be performed at other predefined proximities around the user-defined polygon including at radii larger than 10 km and smaller than 1 km. As an option, a multi-scale analysis can be performed across multiple remote data stores.

The following describes an example implementation where the system 100 of FIG. 1 builds and then, incorporates the index 600 for use in geospatial analysis. A database system can implement a hierarchical geospatial indexing structure to be more effective at spatial querying and analysis, for example, in support of cloud services. Therefore, such a database system can be used to support an application service that provides geospatial querying and analysis in a chatbot mechanism. By way of example, the database system can employ spatial indexing methods to build the index 600 (e.g., a tree-like structure of nodes) that is suitable for efficient geospatial querying and analysis.

According to the hierarchical geospatial indexing structure, a nested (child) container node references its next higher-level (parent) container node, forming the container relationship. In an embodiment, an example node in the index 600 includes geometric data (e.g., coordinates for a spatial extent or area) and various properties that are relevant to the entity such as population and area size. When given a geospatial analysis task and a specific region of a larger geographic area, the system 100 only needs to traverse nodes in the index 600 having geometric data within the specific region. Examples of the various properties are described below as well as illustrated in FIG. 6.

The system 100 of FIG. 1 can organize available geospatial datasets from the integrated data sources into a multi-layered hierarchy where each layer represents both a geographic area and one or more associated data attributes. The base layer 610 refers to the physical geography that is the focus of a user's queries. As a result of specifying the base level 610, the datasets of the higher-level layers are limited the boundaries of a specific geographic area. Some example datasets for the base layer 610 provide fundamental geographic information associated with the terrain, land use, and physical infrastructure. The base layer 610 represents the actual physical world with buildings, roads, and natural features. Datasets mapped to the base layer 610 store base coordinates and boundary polygons. Alternatively, the base layer 610 may refer to the physical infrastructure specifically.

The system 100 may configure, as the layer on top of the base layer 610, the demographic layer 620 for datasets having demographic information. Examples of such information include population statistics, age distribution data, household composition data, cultural demographic data, and/or the like.

The system 100 may configure, as the layer on top of the demographic layer 620, the socio-economic layer 630 for datasets having socio-economic information. Examples of such information include income levels, employment statistics, property values, economic indicators, and/or the like.

The system 100 may configure, as the layer on top of the socio-economic layer 630, the infrastructure access layer 640 for datasets having infrastructure access information. Examples of such information include proximity to public services, transportation access, utility coverage, public facility locations, and/or the like.

The system 100 may configure, as the layer on top of the infrastructure access layer 640, the activity layer 650 for datasets having infrastructure access information. Examples of such information traffic patterns, movement flows, temporal usage patterns, peak activity times, and/or the like.

Similar to the structure 200 of FIG. 3, FIG. 6 depicts the hierarchical geospatial indexing structure of the index 600 as a nested configuration of containers that are each labeled with an appropriate geospatial layer. Each container represents an entity (e.g., a geographic entity), and the nested configuration of containers represents the relationships (e.g., geographic containment relationships) between nested entities. In one embodiment, each container represents a category/level of a specific entity type within a same geographic area.

There are a number of ways to improve upon the above-described index 600. To illustrate a few, the quantity, variety, and/or precision of information in a node's entry can be expanded, for instance, to integrate multiple data sources including proprietary, public, and/or third-party datasets. Examples of public datasets include government census data, environmental quality reports, transportation networks, and/or the like. Examples of proprietary datasets include real estate market data, economic indicators, business directories, and so forth. Examples of other data sources that can be integrated as an additional data source include web-crawled information such as social media geotagged posts, online reviews, crowd-sourced data, and/or the like.

Integrating datasets from the multiple data sources may require that the datasets undergo data harmonization. This may be done to satisfy any number of concerns related to the pending geospatial analysis and as another way to improve the above index 600. In one embodiment, same or similar attribute data from different sources can be standardized to ensure consistency and/or compatibility with any applicable geospatial analysis tasks.

Standardization can refer to format standardization, which includes converting attribute data into a common format or unit value. Another example of a data harmonization process includes attribute mapping where different terminologies/classifications are coupled to each other to facilitate the pending geospatial analysis. Another example of a data harmonization process includes temporal alignment or the synchronizing of data from different time periods. Another example of a data harmonization process includes data update mechanisms that automatically schedule regular updates to keep current the datasets. Another example of a data harmonization process includes change detection algorithms configured to identify and incorporate new or modified data from the multiple data sources. The above examples of standardization and harmonization techniques provide comprehensive and consistent insights.

### 8. Example Dynamic Backend Function Orchestration

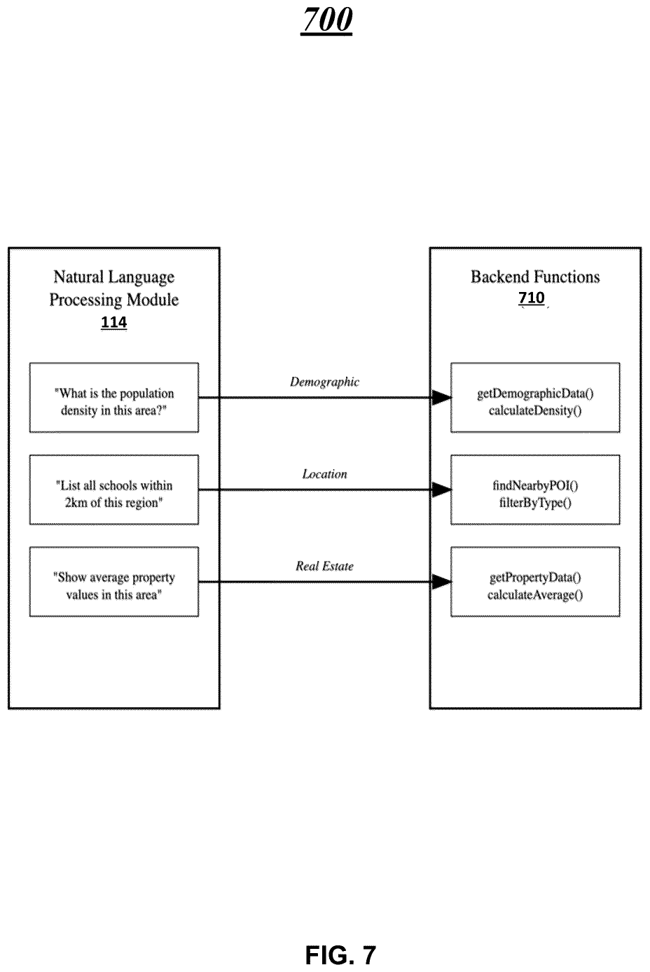

FIG. 7 illustrates a schematic representation of a dynamic function response mechanism 700 in accordance with one or more embodiments. The dynamic function response mechanism 700 operates by mapping interpreted query portions (i.e., tokens) to specific backend functions 710, which when called, perform the necessary analysis tasks to generate an appropriate query response.

In one embodiment, a natural language processing module, such as the NLP module 114 of FIG. 1, is configured to generate mappings between interpreted queries to specific API functions based on query context. Having these mappings enables the system 100 to dynamically select and invoke backend functions based on the query context provided by the NLP module 114. In general, the backend functions are modular and configured for specific tasks such as data retrieval, analysis, or visualization preparation.

To illustrate by way of example, a query that, when interpreted by the NLP module 114, relates to environmental conditions should map to one or more environmental data retrieval functions. This is due to the NLP module 114 determining query intent from both intrinsic and extrinsic factors. Given that the above query would specify the particular environmental conditions to search, the query intent is to search environmental data sources that are germane to the query's specified environmental conditions. The NLP module 114 generates a mapping upon identifying the appropriate environmental data retrieval functions for yielding the specific environmental data being sought for by the user's query. Such a query intent can be deduced by the NLP module 114 using a variety of techniques in addition to or as an alternative of the above description.

Upon generating a mapping between an interpreted query and one or more appropriate backend functions, the NLP module 114 records that mapping in a function registry. In general, the NLP module 114 configures to function registry to maintain a plurality of mappings between query intents and backend functions. The NLP module 114 can employ disambiguation strategies when multiple interpretations are possible and request clarification from the user if necessary.

### 9. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 10. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

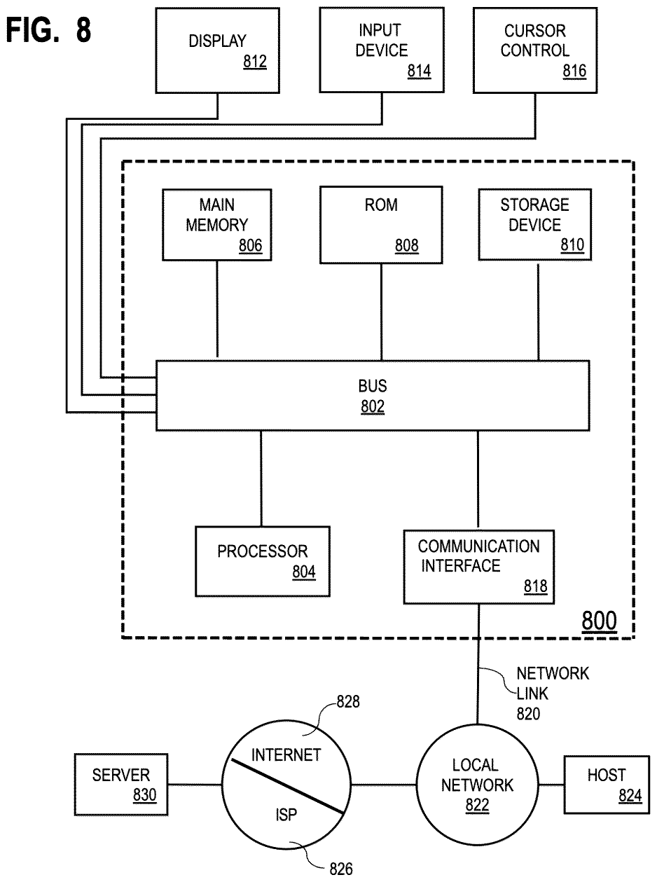

For example, FIG. 8 is a block diagram that illustrates a computer system 800 upon which an embodiment of the disclosure may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or a Solid State Drive (SSD) is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### 11. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
responsive to receiving, from a computing device via a network, a natural language query corresponding to a geographic region, determining a natural language response based on geospatial data retrieved from a database system, wherein the geospatial data is indexed by the database system to maintain geospatial relationships between entities associated with the geographic region;
generating, for output to an electronic display, content configured to present the natural language response; and
wherein the method is performed by at least one hardware processor.

2. The method of claim 1 further comprising receiving, from the computing device via the network, input data comprising a user-defined polygon over a map representation of the geographic region.

3. The method of claim 2 further comprising aggregating datasets at one or more proximities around the user-defined polygon.

4. The method of claim 2 further comprising aggregating datasets at one or more predefined proximities around the user-defined polygon, wherein the one or more predefined proximities are selected from a set consisting of radii of 1 km, 5 km, and 10 km.

5. The method of claim 1, wherein an index for retrieving the geospatial data comprises a hierarchical geospatial indexing structure.

6. The method of claim 5, wherein the index for retrieving the geospatial data comprises a tree structure having a parent node that references a child node when a parent node entity includes a child node entity.

7. The method of claim 5, wherein the index for retrieving the geospatial data is configured for searching datasets from at least one remote data store over the network.

8. The method of claim 1, wherein the geospatial data comprises hierarchically indexed geospatial datasets that are retrieved from a number of data stores.

9. The method of claim 1, wherein determining the natural language response further comprises executing a function set operative to extract the geospatial data from datasets that maintain geospatial relationships between entities in a geographic area that includes the geographic region.

10. The method of claim 1, wherein determining the natural language response further comprises executing a function set operative to extract the geospatial data from a multi-level hierarchically indexed geospatial database that maintains geospatial relationships between entities in the geographic region and entities in the natural language query.

11. The method of claim 1, wherein determining the natural language response further comprises selecting, for a function set operative to extract the geospatial data, one or more functions based on query intent of the natural language query.

12. A system comprising:
at least one device including a hardware processor and configured to perform operations comprising:
responsive to receiving, from a computing device via a network, a natural language query corresponding to a region within a geographic area, determining a natural language response based on geospatial data retrieved from a database system, wherein the geospatial data is indexed by the database system to maintain geospatial relationships between entities associated with the region; and
generating, for output to an electronic display, content configured to present the natural language response.

13. The system of claim 12, wherein the geographic region is selected in response to receiving a user-defined polygon indicative of a portion of a map representation of the geographic area.

14. The system of claim 13, wherein the at least one device is further configured to perform operations comprising aggregating datasets at one or more proximities around the user-defined polygon.

15. The system of claim 12, wherein determining the natural language response further comprises executing a function set operative to extract the geospatial data from datasets that maintain geospatial relationships between entities in the geographic area.

16. The system of claim 15, wherein the datasets are stored in at least one remote data store.

17. One or more non-transitory computer readable media comprising instructions which, when executed by one or more hardware processors, cause performance of operations comprising:
responsive to receiving, from a computing device via a network, a natural language query corresponding to a geographic region, determining a natural language response based on geospatial data retrieved from a database system, wherein the geospatial data is retrieved using an index that maintains geospatial relationships between entities associated with the geographic region; and
generating, for output to an electronic display, content configured to present the natural language response.

18. The non-transitory media of claim 17, wherein the geographic region is selected in response to receiving, from the computing device via a network, input data indicative of a user-defined polygon over a map representation of a geographic area that contains the geographic region.

19. The non-transitory media of claim 17 further comprising instructions which, when executed by one or more hardware processors, cause performance of operations comprising:
aggregating datasets at one or more proximities around a user-defined polygon.

20. The non-transitory media of claim 17, wherein the index comprises a tree structure having a parent node reference a child node when a parent node entity includes a child node entity.
